(19) United States
(12) Patent Application Publication
(10) Pub. No.: US 2024/0397335 A1
(43) Pub. Date: Nov. 28, 2024

(54) Transmission Parameter Decision Method and Related System

(71) Applicant: Realtek Semiconductor Corp., HsinChu (TW)

(72) Inventors: Jhe-Yi Lin, HsinChu (TW); Wun-Ci Su, HsinChu (TW)

(73) Assignee: Realtek Semiconductor Corp., HsinChu (TW)

(21) Appl. No.: 18/527,385

(22) Filed: Dec. 4, 2023

(30) Foreign Application Priority Data
May 24, 2023 (TW) 112119361

(51) Int. Cl. H04W 16/14

(52) U.S. Cl. CPC H04W 16/14

(57) ABSTRACT

A transmission parameter decision method, used for a wireless transmission system with a plurality of user devices, includes (a) determining a plurality of characteristics corresponding to a current scene of the wireless transmission system at a first time point; and (b) determining a plurality of transmission parameters corresponding to each user device of the plurality of user devices at a second time point according to the plurality of characteristics; wherein the plurality of user devices perform wireless transmission using the corresponding plurality of transmission parameters at the second time point; wherein the second time point lags behind the first time point.

### BACKGROUND OF THE INVENTION

### 1. Field of the Invention

The present invention relates to a transmission parameter decision method and a system thereof, and more particularly, to a transmission parameter decision method using Markov decision process and a system thereof.

### 2. Description of the Prior Art

With the advancement of technology, the transmission end in most wireless scenes needs to serve users who use various types of applications at the same time. For example, in a wireless scene of a home network, a user A simultaneously conducts video conferencing and web browsing, and a user B simultaneously conducts online games and live broadcasting. In this circumstance, the wireless communication transmission technology in the wireless scene uses the Orthogonal Frequency-Division Multiple Access (OFDMA) technology and the spatial reuse (Spatial Reuse, SR) mechanism, so that the transmission end in the wireless scene can support multiple user devices to transmit simultaneously and improve spectrum utilization.

### SUMMARY OF THE INVENTION

The present invention is to provide a transmission parameter decision method and the system thereof to solve the above problems.

The present invention provides a transmission parameter decision method, for a wireless transmission system with a plurality of user devices, including (a) determining a plurality of characteristics corresponding to a current scene of the wireless transmission system at a first time point; and (b) determining a plurality of transmission parameters corresponding to each user device of the plurality of user devices at a second time point according to the plurality of characteristics; wherein the plurality of user devices perform a wireless transmission using the corresponding plurality of transmission parameters at the second time point; wherein the second time point lags behind the first time point.

The present invention provides an access point, configured in a wireless transmission system with a plurality of user devices, including a processor; and a memory, coupled to the processor, configured to store a program code for instructing the processor to execute a transmission parameter decision method, wherein the transmission parameter decision method includes: (a) determining a plurality of characteristics corresponding to a current scene of the wireless transmission system at a first time point; and (b) determining a plurality of transmission parameters corresponding to each user device of the plurality of user devices at a second time point according to the plurality of characteristics; wherein the plurality of user devices perform a wireless transmission using the corresponding plurality of transmission parameters at the second time point; wherein the second time point lags behind the first time point.

The present invention provides a user device, for a wireless transmission system, including a wireless communication module; and a memory, coupled to the wireless communication module, configured to store a program code for instructing the wireless communication module to execute the following steps: at a first time point, obtaining a plurality of transmission parameters corresponding to a second time point from an access point of the wireless transmission system; and using the plurality of transmission parameters to perform a wireless transmission with the access point at the second time point; wherein the plurality of transmission parameters are determined by the access point using a transmission parameter decision method, and the transmission parameter decision method includes: (a) determining the plurality of characteristics corresponding to a current scene at the first time point; and (b) determining the plurality of transmission parameters corresponding to the user device at the second time point according to the plurality of characteristics; wherein the second time point lags behind the first time point.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless transmission system according to an embodiment of the present invention.

FIG. 2 is a flowchart of a transmission parameter decision method according to an embodiment of the present invention.

FIG. 3 is a schematic diagram of a transmission parameter decision method according to an embodiment of the present invention.

FIG. 4 is a schematic diagram of a transmission parameter decision method according to another embodiment of the present invention.

FIG. 5 is a schematic diagram of the deep neural network according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

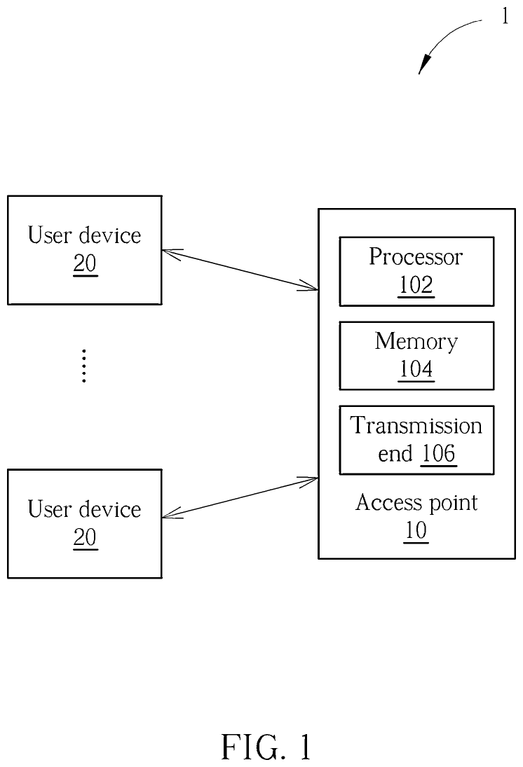

Please refer to FIG. 1. FIG. 1 is a schematic diagram of a wireless transmission system 1 according to an embodiment of the present invention. The wireless transmission system 1 includes an access point (AP) 10 and a plurality of user devices 20. The access point 10 includes a processor 102, a memory 104 and a transmission end 106. The memory 104 stores a program code for instructing the processor 102 to execute a transmission parameter decision method for deciding the plurality of transmission parameters. During the next transmission, a plurality of user devices 20 may perform the wireless transmission with the transmission end 106 of the access point 10 according to the plurality of transmission parameters. A plurality of user devices 20 may include a mobile device, a notebook computer and a smart home appliance, etc., but not limited thereto. Specifically, the plurality of transmission parameters may include a transmission rate, a transmission mode and a transmission power, wherein the transmission rate is a connection rate of each user device during the next transmission; the transmission mode represents a plurality of modes corresponding to various wireless scenes during the next transmission, e.g., Orthogonal Frequency-Division Multiple Access (OFDMA) and Spatial Reuse (SR) mechanism, etc., but not limited thereto; the transmission power is a connection power for the next transmission.

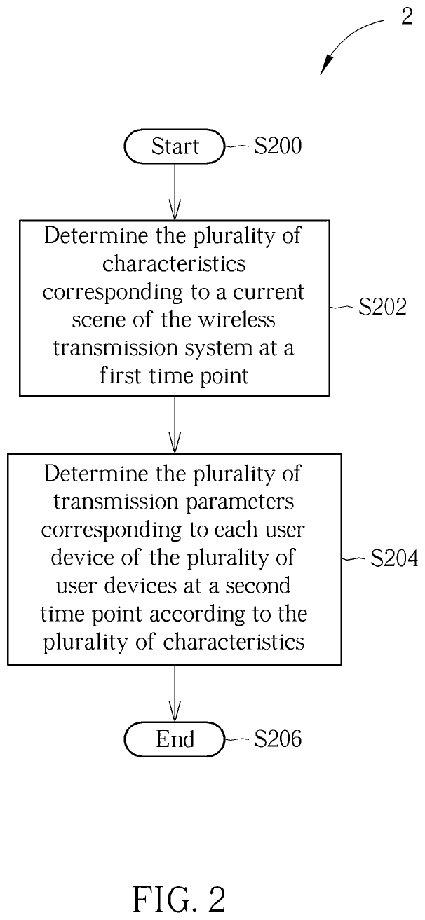

The transmission parameter decision method of the wireless transmission system 1 may be summarized as a process 2, as shown in FIG. 2. The process 2 includes the following steps:

Step S200: Start.

Step S202: Determine the plurality of characteristics corresponding to a current scene of the wireless transmission system at a first time point.

Step S204: Determine the plurality of transmission parameters corresponding to each user device of the plurality of user devices at a second time point according to the plurality of characteristics.

Step S206: End.

According to the process 2, in the step S202, the processor 102 of the access point 10 may determine the plurality of characteristics corresponding to a current scene of the wireless transmission system. The plurality of characteristics may include a user number, a traffic distribution, a category queue, a channel state information (CSI) and a packet error rate (PER). Specifically, the processor 102 may determine the user number that the transmission end 106 needs to serve in a current queue, obtain the traffic distribution from the statistics of data flowing into the current queue, obtain a priority order of an upper-layer application services entering different category queue according to the different quality of service (Qos), obtain the channel state information using to evaluate the transmission mode adopted by the user device, and obtain a packet error rate according to each transmission result. It should be noted that the plurality of characteristics of a current scene of the wireless transmission system only represent necessary features required to implement the transmission parameter decision method. The basic meanings of the plurality of characteristics are well known in the art, and will not be narrated for brevity. Those skilled in the art may add other features as needed to determine the transmission parameters.

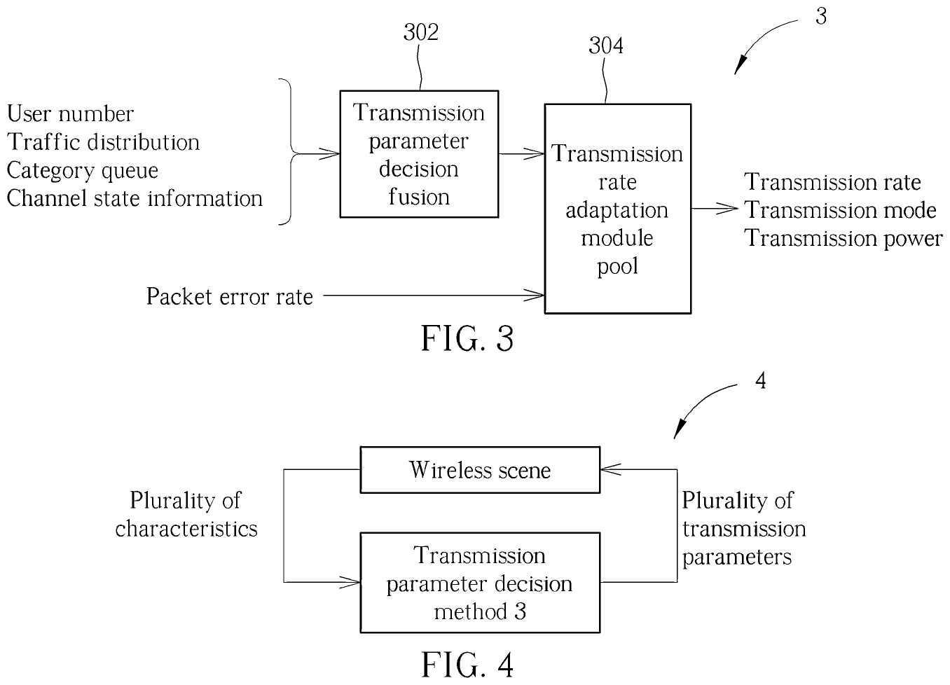

In the step S204, the processor 102 of the access point 10 may determine the plurality of transmission parameters of each user device corresponding to a plurality of user devices at the second time point according to the plurality of characteristics. It should be noted that the second time point lags behind the first time point. For example, the first time point is a current time point, and the second time point is a time point of the next transmission, or the second time point is a time point of a future transmission. Specifically, please refer to FIG. 3. FIG. 3 is a schematic diagram of a transmission parameter decision method 3 according to an embodiment of the present invention. The processor 102 may perform a transmission parameter decision fusion 302 according to the user number, the traffic distribution, the category queue and the channel state information, so as to generate the plurality of transmission modes and the plurality of transmission strategies suitable for current scene. The plurality of transmission modes include a single user (SU) mode, a multi user (MU) mode, a spatial reuse (SR) mode and a resource unit (RU) mode. The plurality of transmission strategies include a through-put (TP) strategy, a stability strategy and a latency strategy. Furthermore, the processor 102 may determine the plurality of transmission parameters by a transmission rate adaptation module pool 304 according to the packet error rate, the plurality of transmission modes and the plurality of transmission strategies, so as to provide to each user device of the plurality of user devices to perform the wireless transmission at the second time point with the access point 10, respectively. In other words, each user device of the plurality of user devices may perform the wireless transmission with the access point 10 according to various transmission parameters. In this way, the embodiment of the present invention may improve the transmission efficiency between each user device of the plurality of user devices and the access point 10, and improve a spectrum utilization rate of the wireless transmission.

It should be noted that, since the scenes of the wireless transmission at different time points may change, and the transmission parameter decision method 3 only determines the plurality of transmission parameters suitable for the current scene according to the plurality of characteristics of the current scene (the first time point). Therefore, the present invention may also use a Markov decision process (MDP) in combination with the transmission parameter decision method 3 to determine the plurality of transmission parameters of various scenes of the wireless transmission. For example, please refer to FIG. 4. FIG. 4 is a schematic diagram of a transmission parameter decision method 4 according to an embodiment of the present invention. Specifically, since the plurality of transmission parameters determined by the transmission parameter decision method 3 at the first time point may be used for the transmission at the second time point, and may affect the wireless scene at the second time point. Therefore, the transmission parameter decision method 4 may re-determine the plurality of transmission parameters of the wireless scene corresponding to the next time point at the second time point according to the plurality of characteristics corresponding to the second time point. In this way, the transmission parameter decision method 4 may provide the best benefit decision in changing wireless scenes.

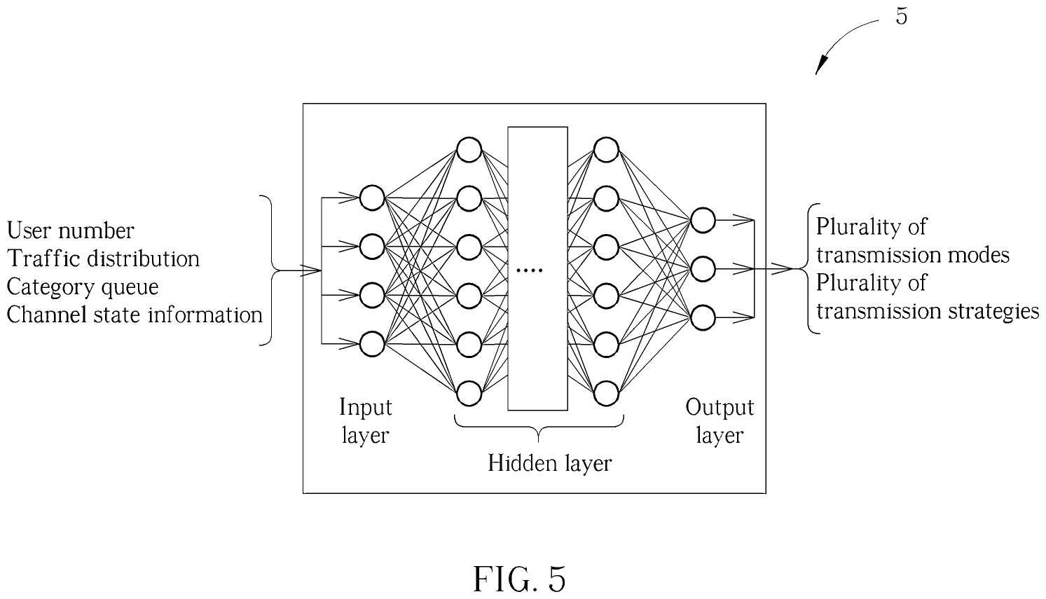

In an embodiment, the transmission parameter decision fusion 302 may use a deep learning method or a reinforcement learning method to determine the plurality of transmission modes and the plurality of transmission strategies in complex wireless scenes. For example, the transmission parameter decision fusion 302 may use a deep neural network (DNN) 5, and FIG. 5 is a schematic diagram of the deep neural network 5 according to an embodiment of the present invention. The deep neural network 5 includes an input layer, a hidden layer and an output layer. The processor 102 may input the user number, the traffic distribution, the category queue and the channel state information to the input layer, and obtain the plurality of transmission modes and the plurality of transmission strategies from the output layer. In this way, the processor 102 may determine the plurality of transmission parameters from the transmission rate adaptation module pool 304 according to the packet error rate, the plurality of transmission modes and the plurality of transmission strategies, so as to provide to each user device of the plurality of user devices to perform the wireless transmission with the access point 10 at the second time point. It should be noted that, the operation of the deep neural network is well known in the art, and will not be narrated for brevity. In addition, the deep learning method or the reinforcement learning method may also use a deep belief network (DBN), a convolutional neural network (CNN) and a convolutional deep belief (CDBN) architecture, but will not limited thereto.

It should be noted that the wireless transmission system 1 is an embodiment of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (COM) and the electronic system. Any of the abovementioned procedures and examples above may be compiled into program codes or instructions that are stored in the memory 104. The memory 104 may include read-only memory (ROM), flash memory, random access memory (RAM), subscriber identity module (SIM), hard disk, or CD-ROM/DVD-ROM/BD-ROM, but not limited thereto. The processor 102 may read and execute the program codes or the instructions stored in the memory 104 for realizing the abovementioned functions.

In summary, the wireless transmission system and the transmission parameter decision method of the present invention may determine the transmission parameters for the transmission at the next time point according to the plurality of characteristics of a current scene, and may also re-determine the transmission parameters in the changing wireless scene. In comparison, the wireless transmission system and the transmission parameter decision method of the present invention may support simultaneous transmission of multiple user devices and improve the spectrum utilization.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission parameter decision method, for a wireless transmission system with a plurality of user devices, comprising:
(a) determining a plurality of characteristics corresponding to a current scene of the wireless transmission system at a first time point; and
(b) determining a plurality of transmission parameters corresponding to each user device of the plurality of user devices at a second time point according to the plurality of characteristics;
wherein the plurality of user devices perform a wireless transmission using the corresponding plurality of transmission parameters at the second time point;
wherein the second time point lags behind the first time point.

2. The transmission parameter decision method of claim 1, wherein the plurality of characteristics comprise a user number, a traffic distribution, a category queue, a channel state information and a packet error rate.

3. The transmission parameter decision method of claim 2, wherein the step (b) further comprises:
using a deep learning method for decision-fusing the user number, the traffic distribution, the category queue and the channel state information, to generate a plurality of transmission modes and a plurality of transmission strategies; and
determining the plurality of transmission parameters of each user device of the plurality of user devices at the second time point from a transmission rate adaptation module pool according to the packet error rate, the plurality of transmission modes and the plurality of transmission strategies.

4. The transmission parameter decision method of claim 3, wherein the deep learning method adopts at least one of a deep neural network, a deep belief network, a convolutional neural network and a convolutional deep belief network.

5. The transmission parameter decision method of claim 3, wherein the plurality of transmission modes comprise a single user mode, a multiple user mode, a spatial reuse mode and a resource unit mode.

6. The transmission parameter decision method of claim 3, wherein the plurality of transmission strategies comprise a throughput strategy, a stability strategy and a latency strategy.

7. The transmission parameter decision method of claim 1, wherein the plurality of transmission parameters comprise a transmission rate and a transmission power.

8. The transmission parameter decision method of claim 1, further comprising:
going to the step (a) at the second time point.

9. An access point, configured in a wireless transmission system with a plurality of user devices, comprising:
a processor; and
a memory, coupled to the processor, configured to store a program code for instructing the processor to execute a transmission parameter decision method, wherein the transmission parameter decision method comprises:
(a) determining a plurality of characteristics corresponding to a current scene of the wireless transmission system at a first time point; and
(b) determining a plurality of transmission parameters corresponding to each user device of the plurality of user devices at a second time point according to the plurality of characteristics;
wherein the plurality of user devices perform a wireless transmission using the corresponding plurality of transmission parameters at the second time point;
wherein the second time point lags behind the first time point.

10. The access point of claim 9, wherein the plurality of characteristics comprise a user number, a traffic distribution, a category queue, a channel state information and a packet error rate.

11. The access point of claim 10, wherein the step (b) further comprises:
using a deep learning method for decision-fusing the user number, the traffic distribution, the category queue and the channel state information, to generate a plurality of transmission modes and a plurality of transmission strategies; and
determining the plurality of transmission parameters of each user device of the plurality of user devices at the second time point from a transmission rate adaptation module pool according to the packet error rate, the plurality of transmission modes and the plurality of transmission strategies.

12. The access point of claim 11, wherein the deep learning method adopts at least one of a deep neural network, a deep belief network, a convolutional neural network and a convolutional deep belief network.

13. The access point of claim 11, wherein the plurality of transmission modes comprise a single user mode, a multiple user mode, a spatial reuse mode and a resource unit mode.

14. The access point of claim 11, wherein the plurality of transmission strategies comprise a throughput strategy, a stability strategy and a latency strategy.

15. The access point of claim 9, wherein the plurality of transmission parameters comprise a transmission rate and a transmission power.

16. The access point of claim 9, wherein the transmission parameter decision method further comprises:
going to the step (a) at the second time point.

17. A user device, for a wireless transmission system, comprising:
a wireless communication module; and
a memory, coupled to the wireless communication module, configured to store a program code for instructing the wireless communication module to execute the following steps:
at a first time point, obtaining a plurality of transmission parameters corresponding to a second time point from an access point of the wireless transmission system; and
using the plurality of transmission parameters to perform a wireless transmission with the access point at the second time point;
wherein the plurality of transmission parameters are determined by the access point using a transmission parameter decision method, and the transmission parameter decision method comprises:
(a) determining the plurality of characteristics corresponding to a current scene at the first time point; and
(b) determining the plurality of transmission parameters corresponding to the user device at the second time point according to the plurality of characteristics;
wherein the second time point lags behind the first time point.
